(19) United States
(12) Patent Application Publication
(10) Pub. No.: US 2007/0164244 A1
(43) Pub. Date: Jul. 19, 2007

(54) Magnet valve

(76) Inventor: Dietmar Kratzer, Tamm (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/653,985

(22) Filed: Jan. 17, 2007

(30) Foreign Application Priority Data
Jan. 19, 2006 (DE) 10 2006 002 638.1

(51) Int. Cl. F16K 31/02

(52) U.S. Cl. 251/129.07

(57) ABSTRACT

The invention relates to a magnet valve, having a valve insert and a tappet guided movably in the valve insert, having a sealing dome which plunges in sealing fashion into a sealing seat of a valve body, and the tappet is movable counter to the spring force of a restoring spring. According to the invention, a bracing bush, disposed outside a flow path in a bore of the valve insert, which receives the restoring spring and braces it and radially guides it from outside.

### REFERENCE TO FOREIGN PATENT APPLICATION

This application is based on German Patent Application No. 10 2006 002 638.1 filed 19 Jan. 2006, upon which priority is claimed.

### BACKGROUND OF THE INVENTION

1. Field of the Invention

The invention is directed to an improved magnet valve of the type used, for example in hydraulic fluid systems.

2. Description of the Prior Art

A conventional magnet valve, in particular for a hydraulic unit, which is used for instance in an antilock brake system (ABS) or a traction control system (TCS) or an electronic stability program system (ESP system), is shown in FIG. 3. As can be seen from FIG. 3, the conventional magnet valve 60, which is open when without current, includes, besides a magnet unit not shown, a valve cartridge that in turn includes a capsule 6, a valve insert 1, a tappet 20 with a sealing dome 21, a restoring spring 30, and an armature 7. In the production of the magnet valve 60, the capsule 6 and the valve insert 1 of the valve cartridge are joined together by pressing, and by means of a sealing lug 8, the valve cartridge is sealed off hydraulically from the atmosphere. In addition, the valve insert 1 absorbs the pressure forces that occur in the hydraulic system and carries them via a calked flange 9 to a calking region, not shown, on a fluid block. In addition, the valve insert 1 receives the so-called valve body 4, which includes a valve seat 10 into which the sealing dome 21 of the tappet 20 plunges in sealing fashion, in order to perform the sealing function of the magnet valve 60. As also seen from FIG. 3, the tappet 20 and the restoring spring 30 are guided in the valve insert 1; the tappet 20 is guided in a tappet guide, and the restoring spring 30 is guided radially on one end on the tappet 20 and centered, and on the other end rests, axially guided, on the valve body 4. The flow path of the fluid through the magnet valve is represented schematically by a chain of arrows 5. Because of its simple assembly, the installation location of the restoring spring 30 is usually disposed in the chamber through which the flow primarily takes place, that is, the region of the through flow 5 of the operating medium. Thus the spring force of the restoring spring 30 is operative in the region of the flow forces that act because of the flow on the turns of the restoring spring 30. As a result, an unwanted influence on the spring behavior can occur from the flow. These influences can for instance be flow forces and deflection forces at the spring turns, a variable flow at variable turn spacings, and so forth. These influences are unknown, variable, and hard to calculate. Hence the restoring spring 30 may for instance lift from its contact with the valve body 4, which may be associated with a corresponding (force) action on the valve tappet 20 and an unwanted influence on the valve function. Moreover, the unguided restoring spring 30 can be laterally deflected or shifted, so that contact and hence frictional forces can occur between the valve insert 1 and the tappet 20. Because of the frictional forces generated, the valve behavior can be adversely affected, and the tappet 20 may be damaged by the spring ends, which may have burrs on them.

### OBJECT AND SUMMARY OF THE INVENTION

The magnet valve of the invention has the advantage over the prior art that a bracing bush, which receives and braces the restoring spring and radially guides it from outside, is disposed outside a flow path in a bore of the valve insert. Because of the local separation, interactions between the restoring spring and the flow can advantageously be reduced sharply, making the behavior of the valve more readily comprehensible and predictable. Furthermore, the restoring spring is guided and centered from outside radially in the valve insert because of the disposition of the bracing bush, so that advantageously, the lateral shifting of the restoring spring caused by force actions, such as transverse forces that act on the turns of the restoring spring, or lifting of the restoring spring from contact, or motion of the turns of the restoring spring relative to one another or their vibration, can be prevented.

By the provisions and refinements disclosed, advantageous improvements to the magnet valve are possible. It is especially advantageous that for force transmission, the bracing bush is coupled to the valve insert via a positive engagement and/or a nonpositive engagement. Thus the bracing bush is introduced into the bore of the valve insert and is braced for instance by means of positive engagement via a collar on an upper end face of the valve insert. In addition or alternatively, the bracing bush can be press-fitted into the bore of the valve insert by means of nonpositive engagement, and as a result the force transmission between the bracing bush and the valve insert is further improved. The bracing bush of the invention makes it advantageously possible for the restoring spring to be removed from the chamber through which the flow primarily takes place, and for most of the other components of the magnet valve that are involved and are time-tested to be adopted without change. Essentially, the tappet is adapted to the use of the bracing bush.

In a feature of the magnet valve of the invention, the bracing bush includes means, preferably slits or interruptions, for volumetric equalization with an armature chamber. The bracing bush is for instance embodied as a plastic injection-molded part.

### BRIEF DESCRIPTION OF THE DRAWINGS

The invention will be better understood and further objects and advantages thereof will become more apparent from the ensuing detailed description of preferred embodiments, taken in conjunction with the drawings, in which:

FIG. 1 is a schematic sectional view of one exemplary embodiment of a magnet valve of the invention;

FIG. 2 is a schematic sectional view of a further exemplary embodiment of a magnet valve of the invention; and

FIG. 3 is a schematic sectional view of a conventional magnet valve.

### DESCRIPTION OF THE PREFERRED EMBODIMENTS

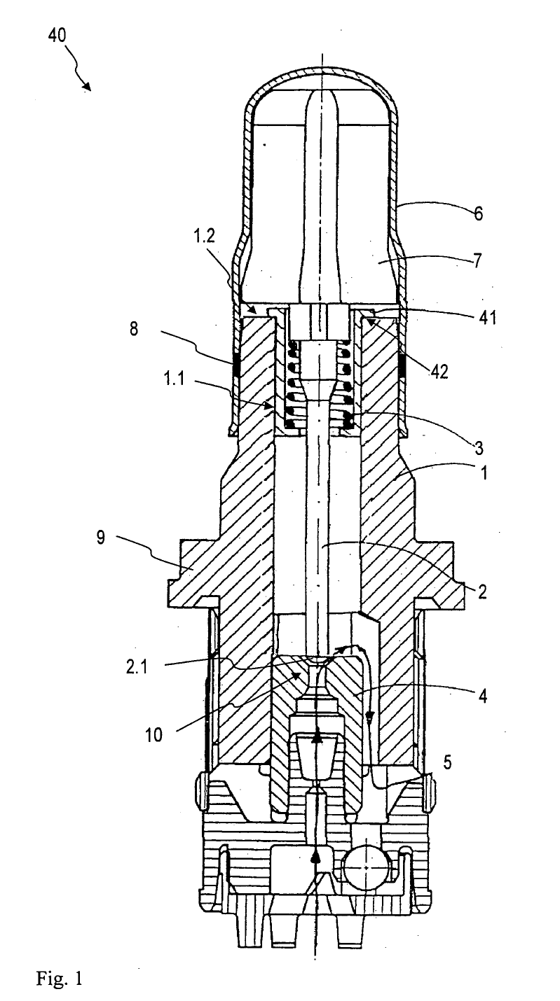

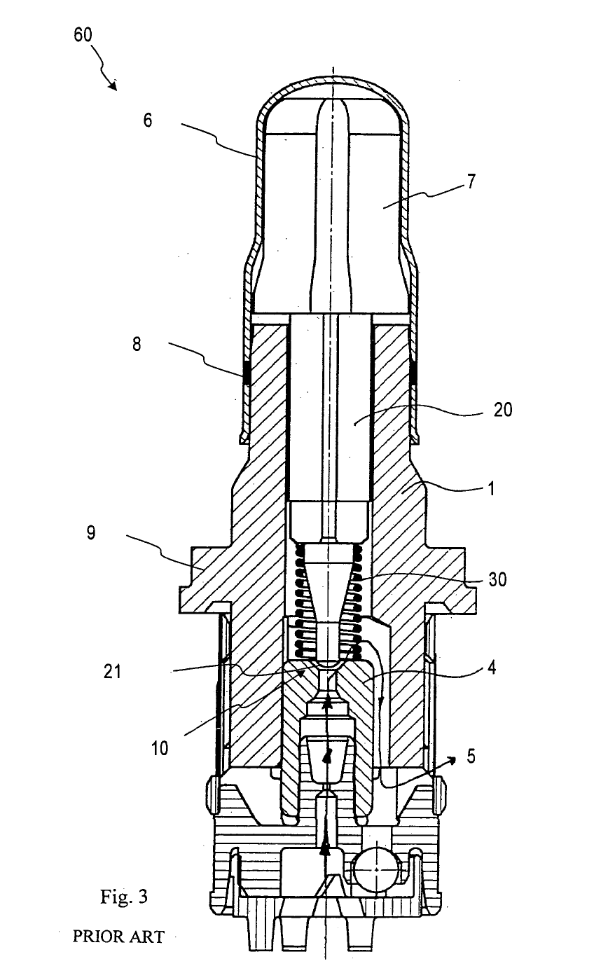

As can be seen from FIG. 1, one exemplary embodiment of a magnet valve 40 of the invention, analogously to the conventional magnet valve 60 of FIG. 3, includes, besides a magnet unit not shown, a valve cartridge, which includes a capsule 6, a valve insert 1, a tappet 2 with a sealing dome 2. 1, a restoring spring 3, and an armature 7. The capsule 6 and the valve insert 1 of the valve cartridge are joined together by pressing, and by means of a sealing lug 8, the valve cartridge is sealed off hydraulically from the atmosphere. In addition, the valve insert 1 absorbs the pressure forces that occur in the hydraulic system and carries them via a calked flange 9 to a calking region, not shown, on a fluid block. In addition, the valve insert 1 receives the so-called valve body 4, which includes a valve seat 10 into which the sealing dome 2.1 of the tappet 2 plunges in sealing fashion, in order to perform the sealing function of the magnet valve 40. The flow path of the fluid through the magnet valve is represented schematically by a chain of arrows 5.

As also seen from FIG. 1, the tappet 2 with the sealing dome 2.1 is guided movably in the valve insert 1. The tappet 2 is movable counter to the spring force of the restoring spring 3, which outside the flow path 5 is received, braced and guided radially from outside by a bracing bush 41. The bracing bush 41 is embodied as a plastic injection-molded part and is disposed in a bore 1.1 of the valve insert 1. In the exemplary embodiment shown, the bracing bush 41 is introduced into the bore 1.1 of the valve insert 1 and is braced by means of positive engagement 42, via a collar, on an upper end face 1.2 of the valve insert 1. Furthermore, the bracing bush 41 includes means, preferably slits or interruptions, for volumetric equalization with an armature chamber.

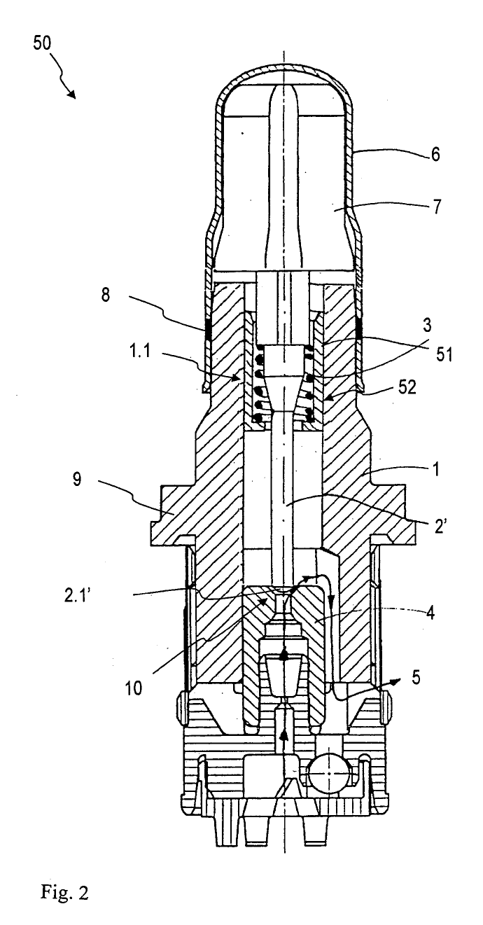

As can be seen from FIG. 2, another exemplary embodiment of a magnet valve 50 of the invention, analogously to the magnet valve 40 of the invention of FIG. 1, includes, besides a magnet unit not shown, a valve cartridge, which includes a capsule 6, a valve insert 1, a tappet 2′ with a sealing dome 2.1′, a restoring spring 3, and an armature 7. The valve insert 1 receives the valve body 4, which includes a valve seat 10 into which the sealing dome 2.1′ of the tappet 2′ plunges in sealing fashion, in order to perform the sealing function of the magnet valve 50. The flow path of the fluid through the magnet valve 50 is represented schematically by a chain of arrows 5. The tappet 2′ with the sealing dome 2.1′ that is guided movably in the valve insert 1 is movable counter to the spring force of the restoring spring 3, which outside the flow path 5 is received, braced and guided radially from outside by a bracing bush 51. Analogously to the bracing bush 41 of FIG. 1, the bracing bush 51 is embodied as a plastic injection-molded part and is disposed in the bore 1.1 of the valve insert 1. In the exemplary embodiment shown, the bracing bush 51 is press-fitted by means of nonpositive engagement 52 into the bore 1.1 of the valve insert 1. The bracing bush 51 likewise includes means, not shown, preferably slits or interruptions, for volumetric equalization with an armature chamber.

The embodiments of the invention described locally separate the restoring spring from the flow, as a result of which interactions can advantageously be reduced sharply. This makes it possible for the behavior of the valve to be more readily comprehensible and predictable. Furthermore, the restoring spring is guided and centered from outside radially in the valve insert because of the disposition of the bracing bush, so that advantageously, the lateral shifting of the restoring spring caused by force actions, such as transverse forces that act on the turns of the restoring spring, or lifting of the restoring spring from contact, or motion of the turns of the restoring spring relative to one another or their vibration, can be prevented.

The foregoing relates to preferred exemplary embodiments of the invention, it being understood that other variants and embodiments thereof are possible within the spirit and scope of the invention, the latter being defined by the appended claims.

I claim:

1. A magnet valve comprising a valve insert, a tappet guided movably in the valve insert, a valve body having a sealing seat, a sealing dome which plunges in sealing fashion into the sealing seat of the valve body, the tappet being movable counter to the spring force of a restoring spring, and a bracing bush, disposed outside a flow path in a bore of the valve insert, which bush receives the restoring spring and braces it and radially guides it from outside.

2. The magnet valve as defined by claim 1, wherein the bracing bush is coupled to the valve insert via a positive engagement and/or a nonpositive engagement.

3. The magnet valve as defined by claim 1, wherein the bracing bush is introduced into the bore of the valve insert and is braced by means of positive engagement via a collar on an upper end face of the valve insert.

4. The magnet valve as defined by claim 2, wherein the bracing bush is introduced into the bore of the valve insert and is braced by means of positive engagement via a collar on an upper end face of the valve insert.

5. The magnet valve as defined by claim 1, wherein the bracing bush is press-fitted into the bore of the valve insert by means of nonpositive engagement.

6. The magnet valve as defined by claim 2, wherein the bracing bush is press-fitted into the bore of the valve insert by means of nonpositive engagement.

7. The magnet valve as defined by claim 3, wherein the bracing bush is press-fitted into the bore of the valve insert by means of nonpositive engagement.

8. The magnet valve as defined by claim 4, wherein the bracing bush is press-fitted into the bore of the valve insert by means of nonpositive engagement.

9. The magnet valve as defined by claim 1, wherein the bracing bush includes means, preferably slits or interruptions, for volumetric equalization with an armature chamber.

10. The magnet valve as defined by claim 2, wherein the bracing bush includes means, preferably slits or interruptions, for volumetric equalization with an armature chamber.

11. The magnet valve as defined by claim 3, wherein the bracing bush includes means, preferably slits or interruptions, for volumetric equalization with an armature chamber.

12. The magnet valve as defined by claim 4, wherein the bracing bush includes means, preferably slits or interruptions, for volumetric equalization with an armature chamber.

13. The magnet valve as defined by claim 5, wherein the bracing bush includes means, preferably slits or interruptions, for volumetric equalization with an armature chamber.

14. The magnet valve as defined by claim 1, wherein the bracing bush is embodied as a plastic injection-molded part.

15. The magnet valve as defined by claim 2, wherein the bracing bush is embodied as a plastic injection-molded part.

16. The magnet valve as defined by claim 3, wherein the bracing bush is embodied as a plastic injection-molded part.

17. The magnet valve as defined by claim 4, wherein the bracing bush is embodied as a plastic injection-molded part.

18. The magnet valve as defined by claim 5, wherein the bracing bush is embodied as a plastic injection-molded part.

19. The magnet valve as defined by claim 9, wherein the bracing bush is embodied as a plastic injection-molded part.

20. The magnet valve as defined by claim 10, wherein the bracing bush is embodied as a plastic injection-molded part.
